(19) United States
(12) Patent Application Publication
(10) Pub. No.: US 2025/0354436 A1
(43) Pub. Date: Nov. 20, 2025

(54) ASSEMBLED CURTAIN

(71) Applicant: Li Lux Co., Ltd., Taichung (TW)

(72) Inventors: Chia-Ling Chang, Taichung (TW); Shu-Fang Jen, Taichung (TW); Fu-Chia Shih, Taichung (TW)

(21) Appl. No.: 19/017,980

(22) Filed: Jan. 13, 2025

(30) Foreign Application Priority Data
May 15, 2024 (TW) 113117973

(51) Int. Cl. E06B 9/386

(52) U.S. Cl. CPC E06B 9/386

(57) ABSTRACT

An assembled curtain includes a crossbar assembly and a curtain fabric. The crossbar assembly includes a first crossbar with a first sidewall, a second sidewall, a first slot, and a first opening. A first flange is disposed on the first sidewall. The curtain fabric includes a first supporting member with a first abutting portion and a second abutting portion, and a fabric sheet with a first end connected to the second abutting portion and a second end extending through the first opening. This configuration ensures a stable and simple structure.

### BACKGROUND OF THE INVENTION

The present invention relates to an assembled curtain, particularly a simple and sturdy assembled curtain.

Traditional panel curtains typically consist of multiple flat curtain fabrics, each suspended from a sliding seat on a sliding track, allowing the fabrics to move along the track. These sliding seats sequentially open or close the fabrics, achieving the opening and closing functionality of traditional panel curtains. However, the connection between each curtain fabric and its corresponding sliding seat relies on hook-and-loop fasteners (commonly known as Velcro). Specifically, the inner surface at the top edge of each curtain fabric and the outer surface of each sliding seat are equipped with the loop side and hook side of the fastener, respectively, for assembly. While this method facilitates convenient assembly, the stability of hook-and-loop fasteners deteriorates over time, leading to the risk of fabric detachment. Additionally, as the weight of the curtain fabric increases, the stability of the fasteners further decreases, significantly undermining the stability of the fabric's installation and assembly.

In view of the aforementioned deficiencies of the conventional structure, the inventor has developed an assembled curtain capable of overcoming all the drawbacks of the traditional structure.

### SUMMARY OF THE INVENTION

An assembled curtain in the embodiment of the present invention includes a crossbar assembly and a curtain fabric. The crossbar assembly includes a first crossbar. The first crossbar is provided with a first sidewall and a second sidewall, a first slot extending horizontally between the first sidewall and the second sidewall, and a first opening connecting the first slot to an exterior of the first crossbar. A first flange is disposed on one side of the first sidewall adjacent to the second sidewall. The curtain fabric includes a first supporting member and a fabric sheet. The first supporting member is provided with a first abutting portion, a second abutting portion, and a first bent portion disposed between the first abutting portion and the second abutting portion. Two opposite surfaces of the first bent portion form a first inner angled surface with an angle smaller than 180 degrees and a first outer angled surface with an angle greater than 180 degrees. The first abutting portion is adjacent to the first sidewall and abuts against the first flange. The second abutting portion is adjacent to the second sidewall. The first inner angled surface faces in a direction opposite to the first opening. The first outer angled surface faces the first opening. The fabric sheet is provided with a first end and a second end opposite to the first end. The first end is connected to the second abutting portion and adjacent to the first outer angled surface. The second end extends outward from the first slot through the first opening.

In an embodiment, the crossbar assembly further includes a second crossbar. The second crossbar is provided with a third sidewall and a fourth sidewall, a second slot extending horizontally between the third sidewall and the fourth sidewall, and a second opening connecting the second slot to an exterior of the second crossbar. A second flange is disposed on one side of the third sidewall adjacent to the fourth sidewall. The curtain fabric includes a second supporting member. The second supporting member is provided with a third abutting portion, a fourth abutting portion, and a second bent portion disposed between the third abutting portion and the fourth abutting portion. Two opposite surfaces of the second bent portion form a second inner angled surface with an angle smaller than 180 degrees and a second outer angled surface with an angle greater than 180 degrees. The third abutting portion is adjacent to the third sidewall and abuts against the second flange. The fourth abutting portion is adjacent to the fourth sidewall. The second inner angled surface faces in a direction opposite to the second opening. The second outer angled surface faces the second opening. The second end is connected to the fourth abutting portion and adjacent to the second outer angled surface. The first end extends outward from the second slot through the second opening.

In an embodiment, a distance from the first flange to the second sidewall forms a first width. A distance from one end of the first sidewall adjacent to the first opening to one end of the second sidewall adjacent to the first opening forms a second width. The first width is smaller than the second width. A distance from the second flange to the fourth sidewall forms a third width. A distance from one end of the third sidewall adjacent to the second opening to one end of the fourth sidewall adjacent to the second opening forms a fourth width. The third width is smaller than the fourth width.

In an embodiment, a distance from one end of the first abutting portion opposite to the first bent portion to the first bent portion forms a fifth width. A distance from one end of the second abutting portion opposite to the first bent portion to the first bent portion forms a sixth width. The fifth width is greater than the first width and smaller than the sixth width. A distance from one end of the third abutting portion opposite to the second bent portion to the second bent portion forms a seventh width. A distance from one end of the fourth abutting portion opposite to the second bent portion to the second bent portion forms an eighth width. The seventh width is greater than the third width and smaller than the eighth width.

In an embodiment, the first opening is disposed at a lower edge of the first crossbar in a vertical direction. The second opening is disposed at an upper edge of the second crossbar in the vertical direction. The first end is disposed at an upper edge of the fabric sheet in the vertical direction. The second end is disposed at a lower edge of the fabric sheet in the vertical direction. The second abutting portion and the fourth abutting portion are connected to the same side of the fabric sheet.

The present invention will become clearer in light of the following detailed description of illustrative embodiments of this invention described in connection with the drawings.

### BRIEF DESCRIPTION OF DRAWINGS

FIG. 1 is a perspective view of an assembled curtain of an embodiment according to the present invention.

FIG. 2 is an exploded perspective view of a first crossbar of the assembled curtain of FIG. 1.

FIG. 3 is a plan view of the first crossbar of the assembled curtain of FIG. 1.

FIG. 4 is an exploded perspective view of a second crossbar of the assembled curtain of FIG. 1.

FIG. 5 is a plan view of the second crossbar of the assembled curtain of FIG. 1.

### DETAILED DESCRIPTION OF THE INVENTION

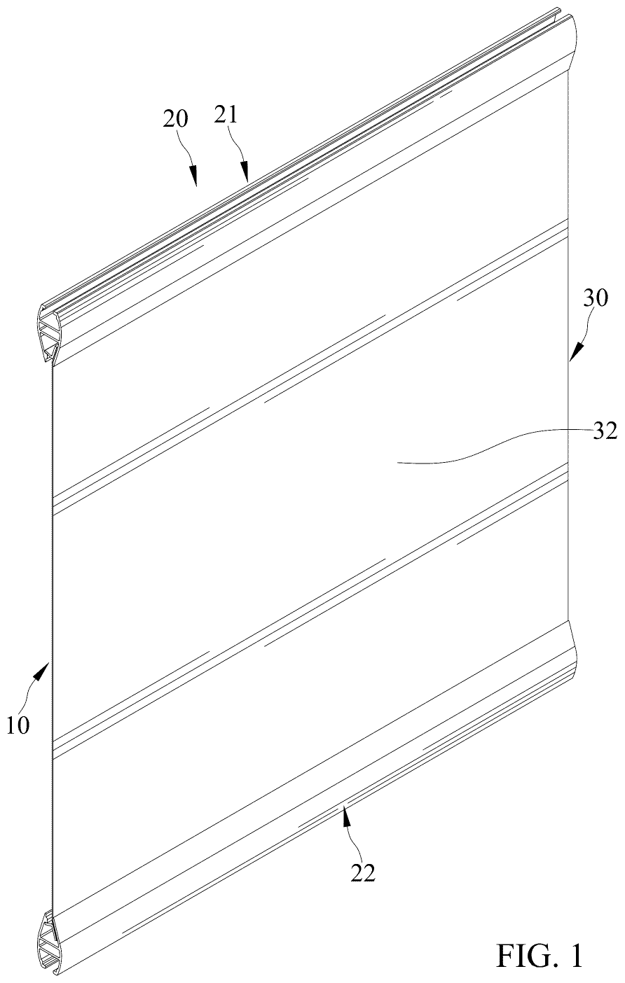

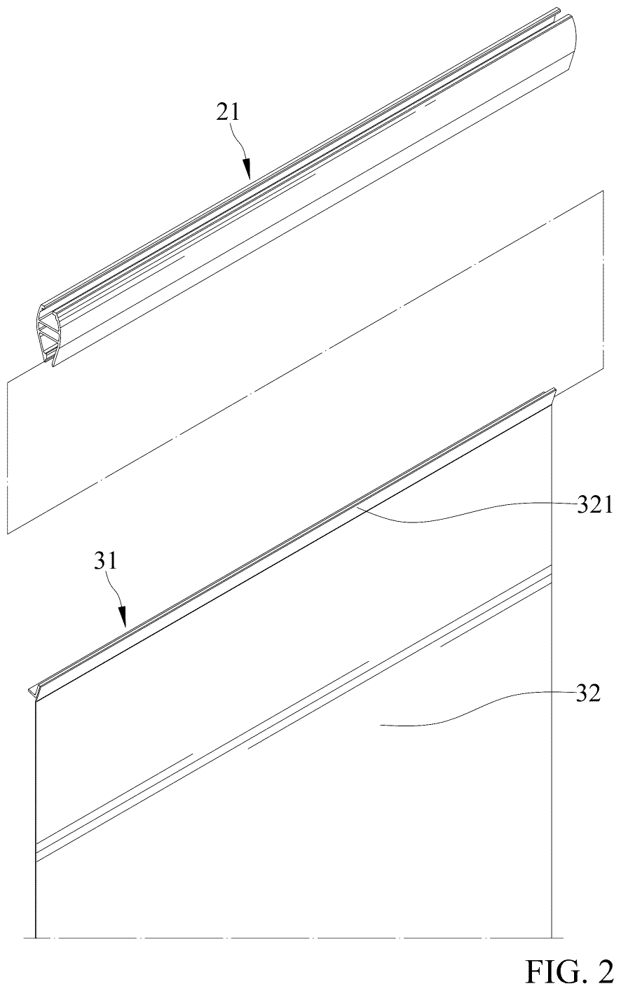

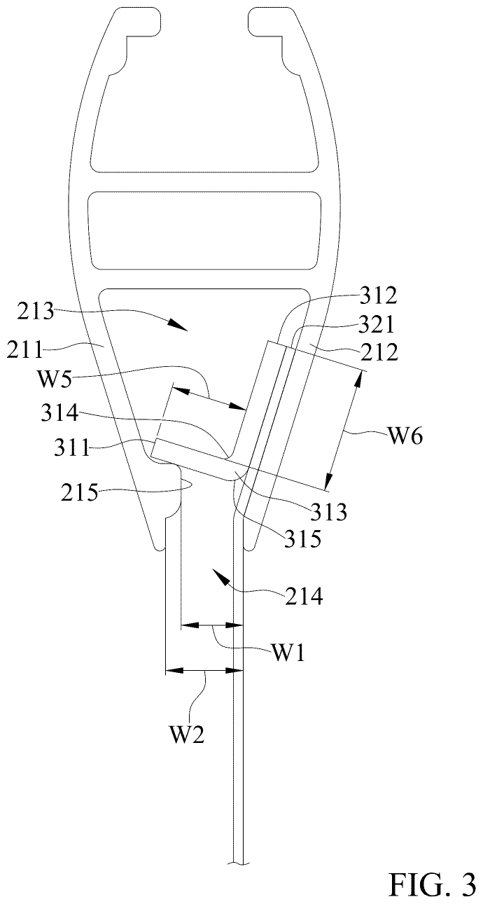

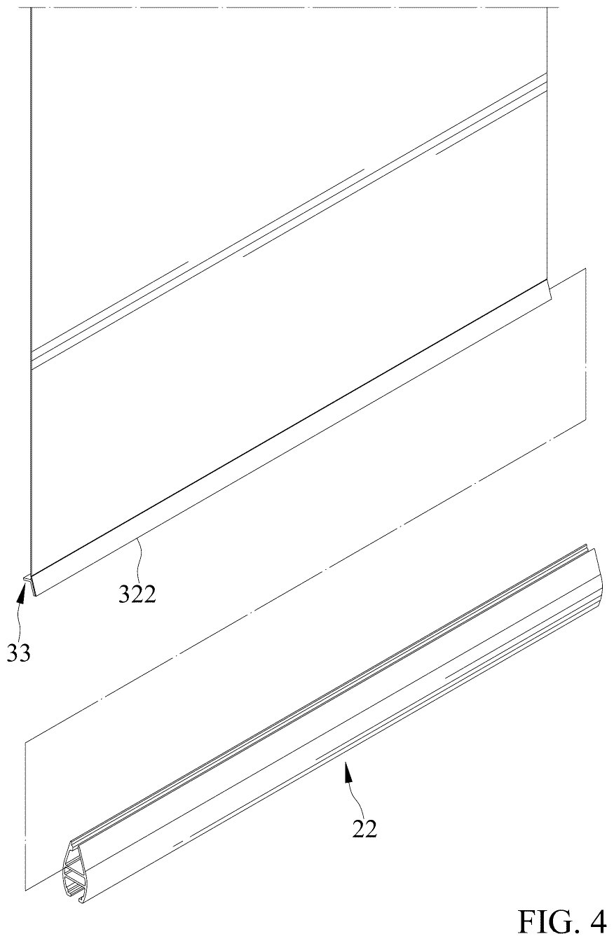

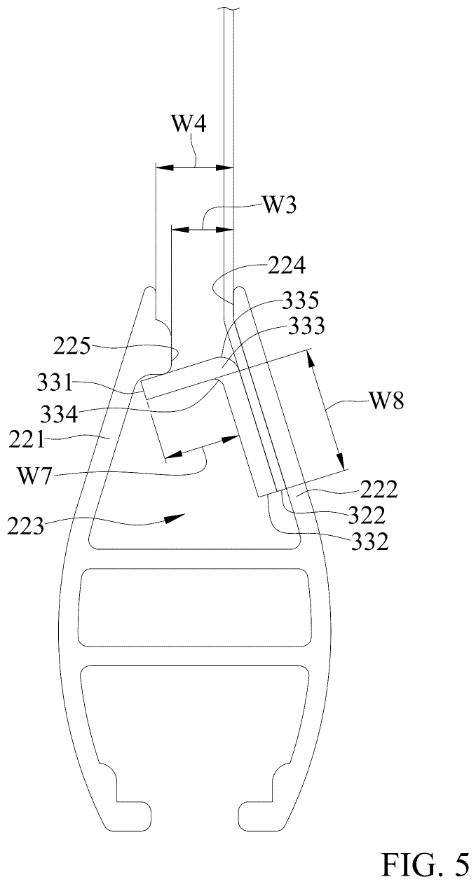

Referring to FIGS. 1 to 5, this embodiment provides an assembled curtain 10, which includes a crossbar assembly 20 and a curtain fabric 30.

The crossbar assembly 20 includes a first crossbar 21. The first crossbar 21 is provided with a first sidewall 211 and a second sidewall 212, a first slot 213 extending horizontally between the first sidewall 211 and the second sidewall 212, and a first opening 214 connecting the first slot 213 to an exterior of the first crossbar 21. A first flange 215 is disposed on one side of the first sidewall 211 adjacent to the second sidewall 212.

The curtain fabric 30 including a first supporting member 31 and a fabric sheet 32. The first supporting member 31 is provided with a first abutting portion 311, a second abutting portion 312, and a first bent portion 313 disposed between the first abutting portion 311 and the second abutting portion 312. Two opposite surfaces of the first bent portion 313 form a first inner angled surface 314 with an angle smaller than 180 degrees and a first outer angled surface 315 with an angle greater than 180 degrees. The first abutting portion 311 is adjacent to the first sidewall 211 and abuts against the first flange 215. The second abutting portion 312 is adjacent to the second sidewall 212. The first inner angled surface 314 faces in a direction opposite to the first opening 214. The first outer angled surface 315 faces the first opening 214. The fabric sheet 32 is provided with a first end 321 and a second end 322 opposite to the first end 321. The first end 321 is connected to the second abutting portion 312 and adjacent to the first outer angled surface 315. The second end 322 extends outward from the first slot 213 through the first opening 214.

The crossbar assembly 20 further includes a second crossbar 22. The second crossbar 22 is provided with a third sidewall 221 and a fourth sidewall 222, a second slot 223 extending horizontally between the third sidewall 221 and the fourth sidewall 222, and a second opening 224 connecting the second slot 223 to an exterior of the second crossbar 22. A second flange 225 is disposed on one side of the third sidewall 221 adjacent to the fourth sidewall 222. The curtain fabric 30 includes a second supporting member 33. The second supporting member 33 is provided with a third abutting portion 331, a fourth abutting portion 332, and a second bent portion 333 disposed between the third abutting portion 331 and the fourth abutting portion 332. Two opposite surfaces of the second bent portion 333 form a second inner angled surface 334 with an angle smaller than 180 degrees and a second outer angled surface 335 with an angle greater than 180 degrees. The third abutting portion 331 is adjacent to the third sidewall 221 and abuts against the second flange 225. The fourth abutting portion 332 is adjacent to the fourth sidewall 222. The second inner angled surface 334 faces in a direction opposite to the second opening 224. The second outer angled surface 335 faces the second opening 224. The second end 322 is connected to the fourth abutting portion 332 and adjacent to the second outer angled surface 335. The first end 321 extends outward from the second slot 223 through the second opening 224.

A distance from the first flange 215 to the second sidewall 212 forms a first width W1. A distance from one end of the first sidewall 211 adjacent to the first opening 214 to one end of the second sidewall 212 adjacent to the first opening 214 forms a second width W2. The first width W1 is smaller than the second width W2. A distance from the second flange 225 to the fourth sidewall 222 forms a third width W3. A distance from one end of the third sidewall 221 adjacent to the second opening 224 to one end of the fourth sidewall 222 adjacent to the second opening 224 forms a fourth width W4. The third width W3 is smaller than the fourth width W4.

A distance from one end of the first abutting portion 311 opposite to the first bent portion 313 to the first bent portion 313 forms a fifth width W5. A distance from one end of the second abutting portion 312 opposite to the first bent portion 313 to the first bent portion 313 forms a sixth width W6. The fifth width W5 is greater than the first width W1 and smaller than the sixth width W6. A distance from one end of the third abutting portion 331 opposite to the second bent portion 333 to the second bent portion 333 forms a seventh width W7. A distance from one end of the fourth abutting portion 332 opposite to the second bent portion 333 to the second bent portion 333 forms an eighth width W8. The seventh width W7 is greater than the third width W3 and smaller than the eighth width W8.

The first opening 214 is disposed at a lower edge of the first crossbar 21 in a vertical direction. The second opening 224 is disposed at an upper edge of the second crossbar 22 in the vertical direction. The first end 321 is disposed at an upper edge of the fabric sheet 32 in the vertical direction. The second end 322 is disposed at a lower edge of the fabric sheet 32 in the vertical direction. The second abutting portion 312 and the fourth abutting portion 332 are connected to the same side of the fabric sheet 32.

The curtain 10 achieves a stable coupling between the curtain fabric 30 and the crossbar 20 through the aforementioned configuration, ensuring a simple structure. By utilizing the first flange 215 to alter the geometry within the first slot 213, a narrow opening is created, preventing the curtain fabric 30 from detaching. Furthermore, this configuration stabilizes the first supporting member 31, making it less prone to overturning and preventing its detachment from the first crossbar 21 due to the fluttering of the fabric sheet 32.

Although specific embodiments have been illustrated and described, numerous modifications and variations are still possible without departing from the scope of the invention. The scope of the invention is limited by the accompanying claims.

1. An assembled curtain, comprising:
a crossbar assembly including a first crossbar, wherein the first crossbar is provided with a first sidewall and a second sidewall, a first slot extending horizontally between the first sidewall and the second sidewall, and a first opening connecting the first slot to an exterior of the first crossbar, and wherein a first flange is disposed on one side of the first sidewall adjacent to the second sidewall; and
a curtain fabric including a first supporting member and a fabric sheet, wherein the first supporting member is provided with a first abutting portion, a second abutting portion, and a first bent portion disposed between the first abutting portion and the second abutting portion, wherein two opposite surfaces of the first bent portion form a first inner angled surface with an angle smaller than 180 degrees and a first outer angled surface with an angle greater than 180 degrees, wherein the first abutting portion is adjacent to the first sidewall and abuts against the first flange, wherein the second abutting portion is adjacent to the second sidewall, wherein the first inner angled surface faces in a direction opposite to the first opening, wherein the first outer angled surface faces the first opening, wherein the fabric sheet is provided with a first end and a second end opposite to the first end, wherein the first end is connected to the second abutting portion and adjacent to the first outer angled surface, and wherein the second end extends outward from the first slot through the first opening.

2. The assembled curtain of claim 1, wherein the crossbar assembly further includes a second crossbar, wherein the second crossbar is provided with a third sidewall and a fourth sidewall, a second slot extending horizontally between the third sidewall and the fourth sidewall, and a second opening connecting the second slot to an exterior of the second crossbar, wherein a second flange is disposed on one side of the third sidewall adjacent to the fourth sidewall, wherein the curtain fabric includes a second supporting member, wherein the second supporting member is provided with a third abutting portion, a fourth abutting portion, and a second bent portion disposed between the third abutting portion and the fourth abutting portion, wherein two opposite surfaces of the second bent portion form a second inner angled surface with an angle smaller than 180 degrees and a second outer angled surface with an angle greater than 180 degrees, wherein the third abutting portion is adjacent to the third sidewall and abuts against the second flange, wherein the fourth abutting portion is adjacent to the fourth sidewall, wherein the second inner angled surface faces in a direction opposite to the second opening, wherein the second outer angled surface faces the second opening, wherein the second end is connected to the fourth abutting portion and adjacent to the second outer angled surface, and wherein the first end extends outward from the second slot through the second opening.

3. The assembled curtain of claim 2, wherein a distance from the first flange to the second sidewall forms a first width, wherein a distance from one end of the first sidewall adjacent to the first opening to one end of the second sidewall adjacent to the first opening forms a second width, wherein the first width is smaller than the second width, wherein a distance from the second flange to the fourth sidewall forms a third width, wherein a distance from one end of the third sidewall adjacent to the second opening to one end of the fourth sidewall adjacent to the second opening forms a fourth width, and wherein the third width is smaller than the fourth width.

4. The assembled curtain of claim 3, wherein a distance from one end of the first abutting portion opposite to the first bent portion to the first bent portion forms a fifth width, wherein a distance from one end of the second abutting portion opposite to the first bent portion to the first bent portion forms a sixth width, wherein the fifth width is greater than the first width and smaller than the sixth width, wherein a distance from one end of the third abutting portion opposite to the second bent portion to the second bent portion forms a seventh width, wherein a distance from one end of the fourth abutting portion opposite to the second bent portion to the second bent portion forms an eighth width, and wherein the seventh width is greater than the third width and smaller than the eighth width.

5. The assembled curtain of claim 2, wherein the first opening is disposed at a lower edge of the first crossbar in a vertical direction, wherein the second opening is disposed at an upper edge of the second crossbar in the vertical direction, wherein the first end is disposed at an upper edge of the fabric sheet in the vertical direction, wherein the second end is disposed at a lower edge of the fabric sheet in the vertical direction, and wherein the second abutting portion and the fourth abutting portion are connected to the same side of the fabric sheet.
